(19) United States
(12) Patent Application Publication
(10) Pub. No.: US 2011/0004919 A1
(43) Pub. Date: Jan. 6, 2011

(54) Method for Processing Emails in a Private Email Network

(75) Inventors: Deepak Chawla, Ocean, NJ (US); William Beckett, Marlboro, NJ (US)

Correspondence Address: AT & T Legal Department - WS;Attn: Patent Docketing, Room 2A-207, One AT & T Way, Bedminster, NJ, 07921, US

(73) Assignee: AT & T Intellectual Property I, L.P., Reno, NV (US)

(21) Appl. No.: 12/496,728

(22) Filed: Jul. 2, 2009

(51) Int. Cl. G06F 15/16; G06F 21/00

(52) U.S. Cl. 726/3; 709/206

(57) ABSTRACT

A postal inspector gatekeeper function is implemented in an electronic email communication system to process email. Various methods of processing email in a private email network approve or reject specific emails for delivery after determining whether the email sender and/or the intended email recipient are included in directories such as a member directory, enterprise member client directory, and a non-member whitelist.

### BACKGROUND OF THE INVENTION

The present invention relates generally to email, and more particularly to a private email network.

Over the last few years, email has become one of the most used forms of communication throughout the world. Like voice communication email is ubiquitous across all societies—communication without boundaries.

However, unlike voice and written forms of communication, email communication inherently has more risks. Two factors responsible for this increased risk: (1) email lacks strong identity verification, and (2) existing email infrastructure provides users the ability to efficiently send an email to a large audience. Consequently, email communication has become plagued with risks, such as, identity theft, scams, fraud, piracy, and stolen intellectual property. And email filters have not been a sufficient mechanism to dampen these risks.

History tells us that security was never an important consideration for email inventors. As a result email security was implemented as an afterthought. The task of filtering out bad email is like trying to contain the spread of a virus that is already airborne. Now that email has been embraced by people in all corners of the world, it has become urgent for entities, like banks and medical establishments, to find a way out this quagmire. This paper outlines an alternative email communication architecture that would be less prone to the security risks that are inherent is the current email delivery infrastructure.

Email communication is different from previous communication methods invented by man since it is global in scope, and “unlimited” in usage. Although conventional postal mail and telephony are ubiquitous in nature, they lend themselves mainly to one-to-one “conversations.” In most cases there is a “face” attached to the conversing parties. The cost and complexity of sending snail mail messages tends to reduce the risk of sending messages to a huge number of recipients. Furthermore, postal inspectors act as gatekeepers and limit the risk to message recipients by preventing the criminal misuse of the snail mail system.

Email came along and provided the tools to uproot the ethical tenets of communication. It provided “speakers” with a cloak of invisibility and an audience of millions of “listeners” around the world. Email, the twenty first century mode of communication, facilitates open communication between rich and poor, strong and weak, good and bad, moral and immoral, or friend and foe. Millions have embraced it. Millions have benefited from it. Some have exploited it. And some have been defrauded by it. In essence, the integrity of the email infrastructure has been corrupted. Ordinary users are being continuously attacked by “invisible” armies, whose objective is to steal, defraud, harass, incapacitate, destroy, and hijack.

Global trends are disheartening. Many emails are unsolicited and unwanted. It has reached a point when smart email filters would be more efficient if they are designed to filter out just the good email, instead of detecting and blocking bad email. Internet is becoming a huge transportation system for hauling garbage. Not only that, the garbage is being dumped at the users' doorsteps.

In addition, the attackers have become more sophisticated with time. Attackers are able to develop technically sophisticated malware, disguise it in an almost “genuine” email package, and deliver it to a small targeted set of users, such as, executives of a single corporation. Most gateway and desktop email security solutions are ineffective against such attacks.

Both business and consumers are victims of email attacks. It is difficult to measure, but it is obvious that “unwanted” email has a negative impact on user productivity, as well as cost to the business. What is needed is a way to stop the deluge of “unwanted” email without “rewriting” the current email system and still maintain the “user experience” of the current email system.

### BRIEF SUMMARY OF THE INVENTION

The present invention generally provides methods for processing emails in a Private Email Network.

In one embodiment, a method for processing an email from an enterprise member to an intended email recipient includes determining if the intended email recipient is included in an enterprise member client directory and in a member directory.

In another embodiment, a method for processing an email from an email sender to an enterprise member includes determining if the email sender is included in a member directory and an enterprise member client directory.

In yet another embodiment, a method for processing an email from an email sender to an intended email recipient includes determining if the email sender is included in a member directory and if the email recipient is included in a non-member whitelist associated with the email sender.

In still yet another embodiment, a method for processing an email from an email sender to an intended email recipient includes determining if the intended email recipient is included in a member directory and if the email sender is included in a non-member whitelist associated with the intended email recipient.

These and other advantages of the invention will be apparent to those of ordinary skill in the art by reference to the following detailed description and the accompanying drawings.

### BRIEF DESCRIPTION OF THE DRAWINGS

FIG. 1 depicts a Private Email Network according to one embodiment;

FIG. 2 depicts a flowchart illustrating a method for processing an email from an enterprise member to a subscriber member according to an embodiment of the present invention;

FIG. 3 depicts a flowchart illustrating a method for processing an email from a subscriber member to an enterprise member according to another embodiment of the present invention;

FIG. 4 depicts a flowchart illustrating a method for processing an email from a subscriber member to a non-member according to another embodiment of the present invention;

FIG. 5 depicts a flowchart illustrating a method for processing an email from a non-member to a subscriber member according to another embodiment of the present invention; and

FIG. 6 depicts a high-level block diagram of a computer which may be used to implement the entities of the private email network shown in FIG. 1.

### DETAILED DESCRIPTION

A postal inspector gatekeeper function is implemented in an electronic email communication system to process email. The infrastructure of the electronic email communication system is open for members and legitimate non-members, but “closed” for intruders. Communication between registered members does not require the registered members to perform additional steps but non-members are required to announce themselves and get “permission” before being allowed in.

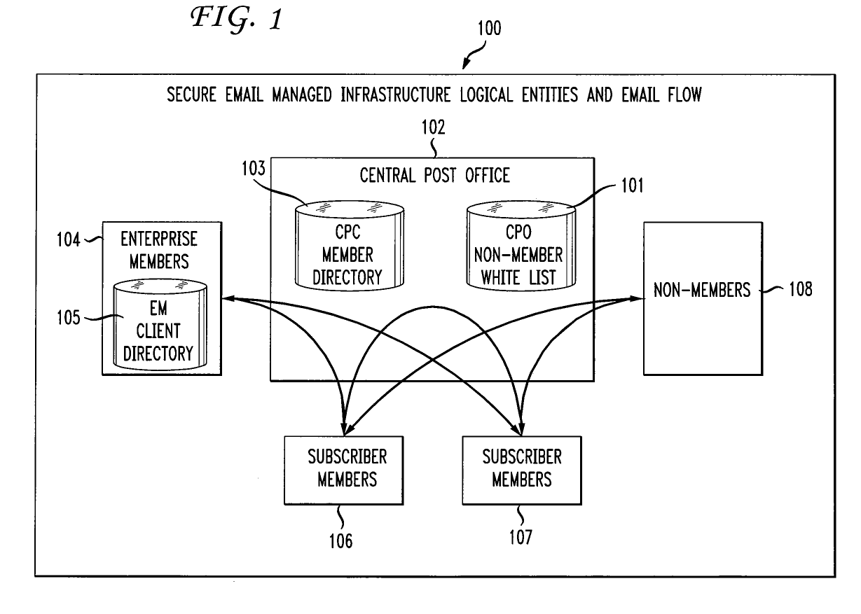

FIG. 1 depicts a Private Email Network (PEN) 100 including multiple entities. PEN 100 is shown including four entity types, namely, Central Post Office (CPO) 102, Enterprise Member (EM) 104, Subscriber Members (SM) 106 and 107, and Non-Member (NM) 108. CPO 102 is the controller and clearing house of all email communications between Enterprise Members, Subscriber Members, and Non-Members associated with PEN 100.

Central Post Office (CPO) 102 is the central hub for email communication between senders and recipients and, in one embodiment, is a server. CPO 102 has its own domain name and capability to establish secure connectivity with both senders and recipients. CPO 102, in one embodiment, has capability to act as a proxy for Enterprise Members 104 and can provide a secure environment for Subscriber Members 106 and 107 to access websites of Enterprise Members 104. In one embodiment, access to enterprise member 104 websites by subscriber members 106 and 107 is limited to accessing websites identified by links contained in email messages from enterprise members 104 to subscriber members 106 and 107. In one embodiment, CPO 102 includes CPO member directory 103, which contains the identification and member information of all members of CPO 102, and CPO non-member whitelist 101 which contains the identification and information of non-members of PEN 100.

Enterprise Member (EM) 104, in one embodiment, is a server associated with an entity or organization (e.g. a bank or an insurance company). Multiple enterprise members may be associated with a single server. EM 104 has an established trust relationship with CPO 102. EM 104, in one embodiment, has a directory database 105 containing the identification and subscriber account information of all its clients (also referred to as subscribers, e.g. subscriber members 106 and 107) referred to as an enterprise member client directory 105. CPO 102, in one embodiment, automatically maps a unique email ID for each EM client (e.g. Enterprise_Member@PEN.net).

Subscriber Member (SM) 106, in one embodiment is a computer associated with a subscriber or an individual (e.g. an account holder of a bank). It should be noted that SM 107 is similar to SM 106 except that SM 107 is associated with a different subscriber member than SM 106 and the description of SM 106 applies to SM 107 as well. Subscriber Member 106 is a client of Enterprise Member 104. SM 106 has a trust relationship with CPO 102. SM 106 has an email account in the PEN 100 domain, e.g. Subscriber_Member@PEN.net. The user associated with SM 106 has installed a trusted email client and authenticated the client with CPO 102. Non-Member (NM) 108 is not a subscriber member of PEN 100 but is allowed to communicate with a SM in the PEN.net domain. NM 108 has a valid email return address. NM 108 is “known” to SM 106 and SM 106 agrees to include NM 108 in a non-member whitelist associated with SM 106. In one embodiment, non-member 108 is indicated as a non-member to subscriber member 106 in the subscriber member's client email application.

EM 104 is configured to communicate with SM 106 and 107 via CPO 102. SM 106 and 107 are configured to communicate with each other, EM 104, and NM 108 via CPO 102. NM 108 is configured to communicate with SM 106 and 107 via CPO 102.

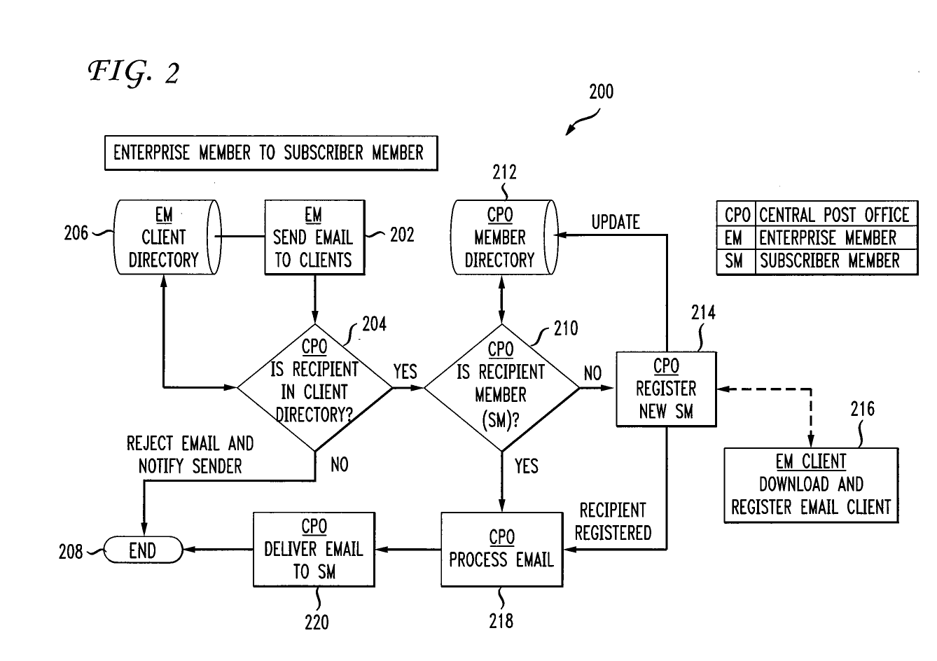

The flow of email between the entities shown in FIG. 1 will now be described in connection with FIGS. 2-5. Enterprise Members are able to communicate with Subscriber Members. EM 104 has an enterprise email address, such as Enterprise_Member@PEN.net, Typically, EM 104 sends email to its individual clients (SMs). For example, a bank sending monthly statements to clients, or an insurance company exchanging email with its clients regarding insurance claims. EM 104 maintains an updated database directory of individual clients. CPO will have access to this database directory which is also referred to as an enterprise member client directory. CPO will reject email from EM 104 to unregistered individual clients, i.e. individual clients not listed in the directory database of the Enterprise Member.

FIG. 2 depicts a flow chart illustrating the processing of an email sent from EM 104 to SM 106. At step 202, EM 104 transmits an email addressed to an intended email recipient to CPO 102. At step 204, CPO 102 determines if the intended email recipient is a subscriber member, such as SM 106, of PEN 100 by comparing the intended email recipient's address with a client listing in EM client directory 206. If the intended email recipient is not included in EM client directory 206, the email is rejected and not delivered to the intended email recipient. The sender of the email, in this case EM 104, is notified that the email has been rejected and the processing of the email ends at step 208.

If at step 204, CPO 102 determines that the intended email recipient is listed in EM client directory 206, the process proceeds to step 210. At step 210, CPO 102 determines if the intended email recipient is included in CPO member directory 212. If the intended email recipient is not listed in member directory 212, CPO 102 can initiate registration of the intended email recipient at step 214. At step 214, in one embodiment, in response to a request from EM 104 to initiate registration of an individual as a subscriber member, CPO 102 transmits a message to a user identified by EM 104. In one embodiment, the message includes an EM/SM validation procedure which requires a shared secret between non-member 108 and EM 104. The recipient of the message should recognize EM 104 (e.g. a non-member who recently became an account holder of an enterprise member such as a bank, should recognize that the message as being associated with the bank). In one embodiment, EM/SM validation requires the message recipient to enter a specific response to the shared secret. The shared secret transmitted to the message recipient validates the registration request as being from enterprise member 104 or an agent of enterprise member 104. If the message recipient enters the correct specific response to the shared secret included in the message, the registration process continues to step 216. In step 216, registration of an intended email recipient as a subscriber member can occur after the potential member has downloaded and registered an email client with CPO 102. Once registered, the intended email recipient is added to CPO member directory 212 and the process proceeds to step 218.

Returning to step 210, if CPO 102 determines that the intended email recipient is included in CPO member directory 212, then the process proceeds to step 218. At step 218, the email is designated as approved for delivery.

At step 220, the header of each email designated as approved for delivery is transmitted to the intended email recipient, in this case, subscriber member 106, in response subscriber member 106 initiating the trusted and authenticated email client. The header of each email designated for delivery may also be transmitted to subscriber member 106 in response to a request from subscriber member 106 to fetch email after the subscriber member has initiated their trusted and authenticated email client. In response to a request for a subscriber to view an entire email associated with an email header, the entire requested email is transmitted to the subscriber member's email client. The process then proceeds to step 208 which ends the particular iteration of process 200 for a single email transmitted from an enterprise member to an intended email recipient.

In one embodiment, each email header is linked to its message body (email content) located at CPO 102. When SM 106 clicks on an email header, the email client will display the message body. If EM 104 has not prohibited downloading, SM 106 will be able to download the email content to SM 104's personal computer. However, if EM 104 has designated the email to be “ready-only,” SM 106 will only be able to read and respond to it, but will be not able to download the email content. In some embodiments, the trusted email client associated with SM 106 is integrated with existing email tools.

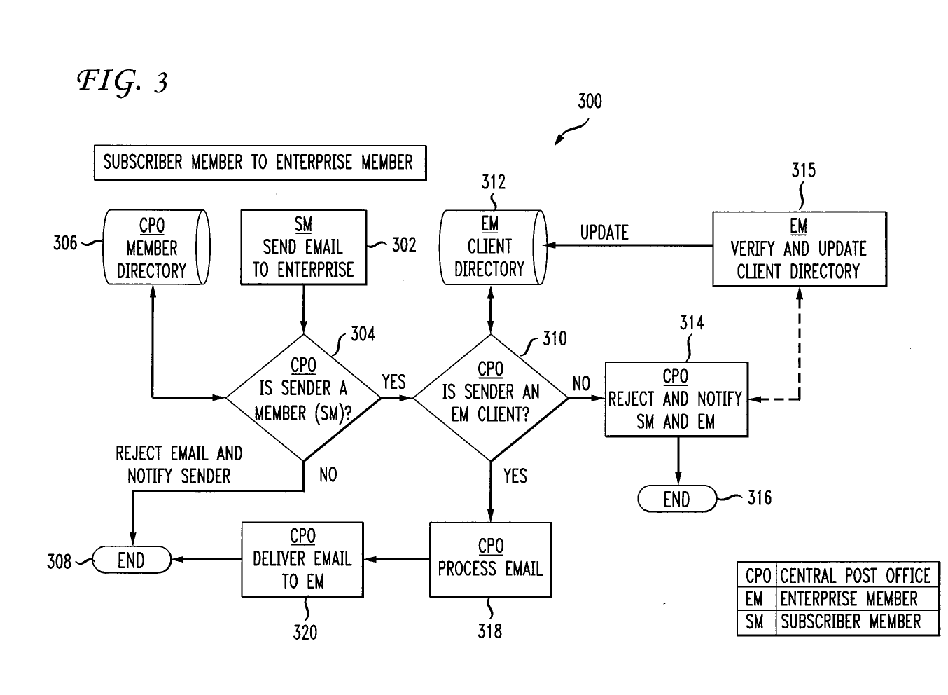

FIG. 3 depicts a flow chart illustrating the processing of an e-mail sent from SM 106 to EM 104. Process 300 starts at step 302 wherein an e-mail sender transmits an e-mail addressed to an intended e-mail recipient to CPO 102. At step 304 CPO 102 determines if the e-mail sender is included in CPO member directory 306. If CPO 102 determines that the e-mail sender is not included in CPO member directory 306, the e-mail is rejected and a notification is sent to the e-mail sender and the process ends at step 308. If CPO 102 determines that the e-mail sender is included in CPO member directory 306, the process continues to step 310 wherein CPO 102 determines if the e-mail sender is included in EM client directory 312. If CPO 102 determines that the e-mail sender is not included in EM client directory 312, the process proceeds to step 314. At step 314 CPO 102 rejects the e-mail and transmits rejection notifications to the e-mail sender and EM 104 after which the process proceeds to step 316 and ends. If at step 310, CPO 102 determines that the sender is included in EM client directory 312, the process proceeds to step 318 where the e-mail is designated as approved for delivery. The process then proceeds to step 320, wherein the email designated as approved for delivery is transmitted to EM 104 in response to a request for email from EM 104. The process then proceeds to step 308 which ends the particular iteration of process 300 for a single e-mail transmitted from an enterprise number to an intended e-mail recipient.

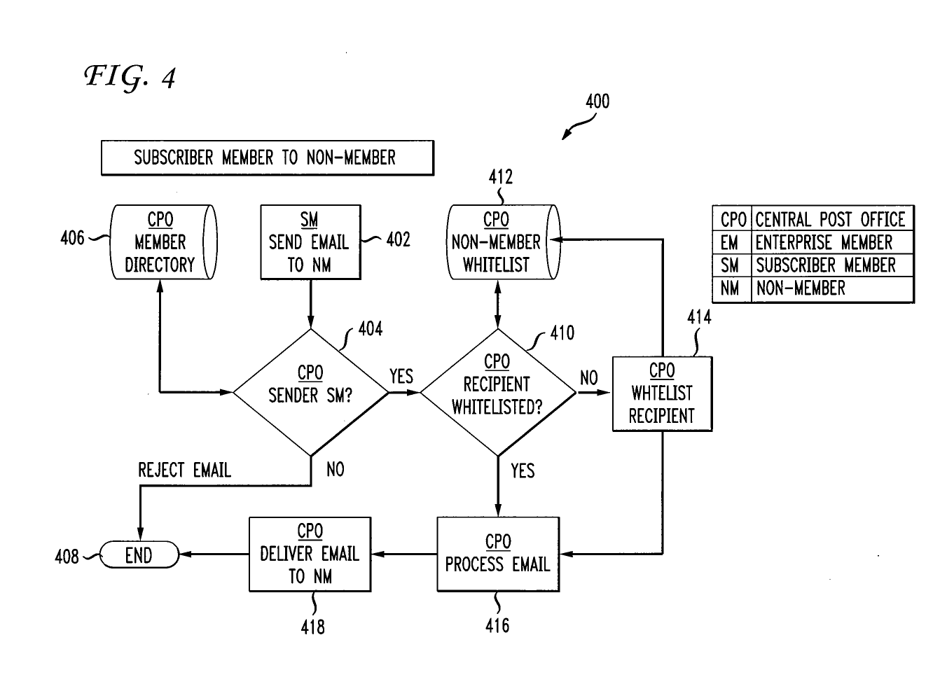

FIG. 4 depicts a flow chart illustrating the processing of an e-mail from SM 106 to NM 108. Process 400 starts at step 402 where an e-mail sender transmits an e-mail to an intended e-mail recipient via CPO 102. The process proceeds to step 404 wherein CPO 102 determines if the e-mail sender is included in CPO member directory 406. If CPO 102 determines that the e-mail sender is not included in CPO member directory 406, the email is rejected and the process proceeds to step 408 which ends the particular iteration of process 400 for a single e-mail transmitted from an email sender to an intended email recipient. If at step 404 CPO 102 determines that the e-mail sender is included in CPO member directory 406, the process proceeds to step 410 where CPO 102 determines if the intended e-mail recipient is included in a non-member white list 412 associated with subscriber member 106 (i.e. the email sender). If CPO 102 determines that the intended e-mail recipient is included in non-member whitelist 412, the process proceeds to step 416 where the e-mail is designated as approved for delivery. If at step 410, CPO 102 determines that the intended e-mail recipient is not included in non-member whitelist 412, the process proceeds to step 414 wherein CPO 102 adds the intended e-mail recipient's address to non-member white list 412. After the intended e-mail recipient's address is added to non-member white list 412 the process proceeds to step 416 wherein the e-mail is designated as approved for delivery. After step 416, the process then proceeds to step 418 wherein CPO 102 delivers e-mails to non-members designated approved for delivery to non-members. The process then proceeds to step 408 where it ends for this particular iteration of process 400 for a single e-mail transmitted from a subscriber member to a non-member.

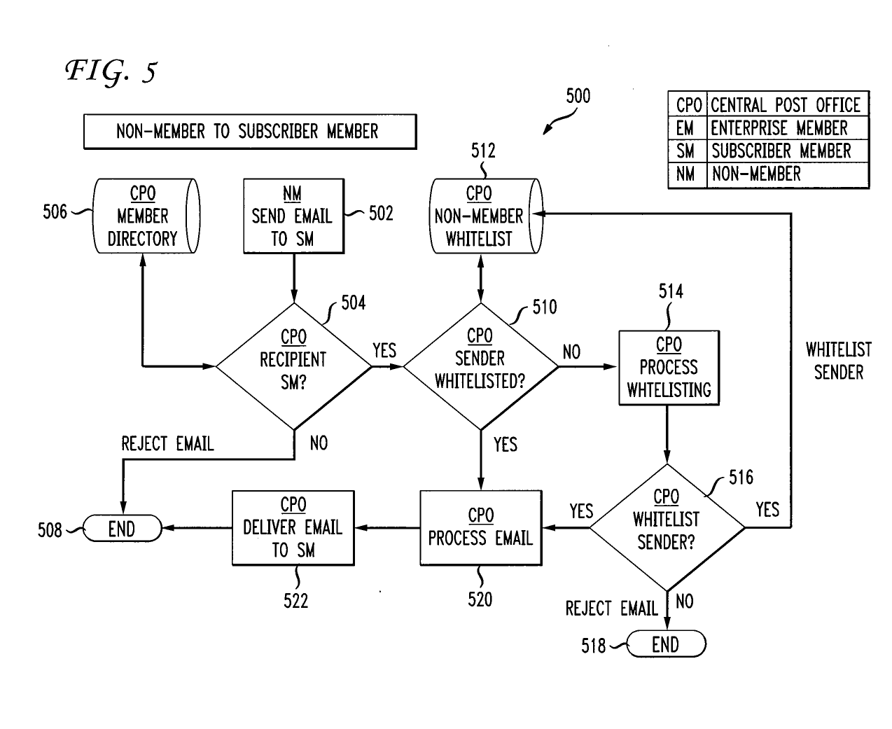

FIG. 5 depicts a flow chart illustrating the processing of an e-mail from a non-member 108 to a subscriber member 106. Process 500 begins at step 502 where an e-mail sender transmits an e-mail addressed to an intended recipient to CPO 102. At step 504 CPO 102 determines if the intended e-mails recipient's address is included in member directory 506. If the intended e-mail recipient is not included in member directory 506, the e-mail is rejected and the process proceeds to step 508 where it ends. If the intended e-mail recipient is included in member directory 506, the process proceeds to step 510. At step 510 CPO 102 determines if the e-mail sender is included in non-member whitelist 512. If the e-mail sender is included in non-member whitelist 512 at step 510, the process proceeds to step 520 wherein CPO 102 designates the e-mail as approved for delivery. At step 522 the header of each e-mail designated as approved for delivery is transmitted to SM 106 in response to SM 106 initiating their trusted and authenticated e-mail client. In response to a request from SM 106 to view the complete e-mail, the requested e-mail is transmitted to SM 106's e-mail client. The process then proceeds to step 508 which ends the particular iteration of process 500 for a single e-mail transmitted from a non-member 108 to subscriber member 106.

If at step 510 CPO 102 determines that the e-mail sender is not included in non-member whitelist 512, the process proceeds to step 514. At step 514 CPO 102 generates a query which is transmitted to intended e-mail recipient identified as subscriber member 106 of PEN 100. At step 516 subscriber member 106 is provided an option to include the e-mail sender to non-member whitelist 512. If at step 516, subscriber member 106 approves the e-mail sender, the e-mail sender is added to non-member white list 512. If at step 516 subscriber member chooses not to white list the e-mail sender, the e-mail is rejected and the process proceeds to step 518 where the process ends.

In one embodiment, after completing a registration process such as the process described above in connection with step 214 of FIG. 2, subscriber members 106 and 107 can download and install email clients from CPO 102. In one embodiment, SM 106 and 107 will need to authenticate the email client and establish a trusted relationship with CPO 102 before being added to CPO member directory 406. In one embodiment, CPO 102 will establish a secure connection with the trusted client, i.e. transport will be encrypted.

In some embodiments, CPO 102 is the centralized gateway for all outbound email of PEN 100's Institution Clients (i.e. enterprise members) and will offer one or more of the following services: secure environment, email security platform to process all inbound messages, anti-virus, anti-spam, content control, image filtering, link investigation tool, sender authentication, anti-bot, anti-phishing, email reading environment, allow recipients to read their messages at the CPO, allow recipients to download non-secure messages, allow recipients to respond to messages at the CPO, prevent secure messages from be downloaded, allow Institution Senders to accept replies from only CPO 102, allow only messages composed at CPO to be sent through the CPO email gateways, provide a web proxy environment, allow CPO 102 to act as a web proxy for institutional clients, and allow recipients to visit websites contained in messages from institutional senders. In one embodiment, the web proxy functionality is limited in scope to Uniform Resource Listings (URLs) which are included in messages to SM 106 or 107 and the web proxy will return a failure code for URLs which have not been added to this function for a given EM, such as EM 104. It should be noted that, in some embodiments, wildcards may be used to identify a set of URLs SM 106 to 107 may access (e.g., www.fidelity.com/brokerage/*). In one embodiment, websites may be restricted to recipients of messages through CPO 102. In some embodiments, transactions through CPO 102 would be secure, e.g. virtual keypad for log-in to financial institutions. It some embodiments, a single CPO can support multiple EMs.

It should be noted that although the architecture uses the industry sectors as a rationale and basis of the architecture of the proposed solution, the design is applicable to the email community at large, including consumers. For instance, a consumer ISP can develop a central post office infrastructure for its subscribers.

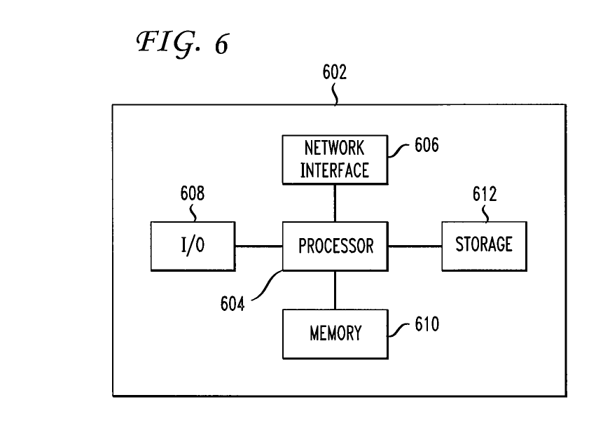

Each of the entities shown in FIG. 1 may be implemented on a computer. A high-level block diagram of such a computer is illustrated in FIG. 6. Computer 602 contains a processor 604 which controls the overall operation of the computer 602 by executing computer program instructions which define such operation. The computer program instructions may be stored in a storage device 612, or other computer readable medium (e.g., magnetic disk, CD ROM, etc.), and loaded into memory 610 when execution of the computer program instructions is desired. Thus, the method steps of FIGS. 3-5 can be defined by the computer program instructions stored in the memory 610 and/or storage 612 and controlled by the processor 604 executing the computer program instructions. For example, the computer program instructions can be implemented as computer executable code programmed by one skilled in the art to perform an algorithm defined by the method steps of FIGS. 2-5. Accordingly, by executing the computer program instructions, the processor 604 executes an algorithm defined by the method steps of FIGS. 2-5. The computer 602 also includes one or more network interfaces 606 for communicating with other devices via a network. Computer 602 also includes input/output devices 608 that enable user interaction with the computer 602 (e.g., display, keyboard, mouse, speakers, buttons, etc.) One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for processing emails from an enterprise member to an intended email recipient in a private email network (PEN) comprising the steps of:
receiving an email at a central post office from an enterprise member addressed to an intended email recipient;
determining at the central post office if the intended email recipient is listed in an enterprise member client directory;
determining at the central post office if the intended email recipient is a subscriber member of the PEN;
designating the email approved for delivery in response to determining that the intended email recipient is listed in the enterprise member client directory and the intended email recipient is a subscriber member of the PEN.

2. The method of claim 1 further comprising the step of designating the email as rejected and notifying the enterprise member of the rejection in response to determining that the intended email recipient is not listed in the enterprise member client directory.

3. The method of claim 1 further comprising transmitting an offer to the intended email recipient to register as a subscriber member of the PEN in response to determining that the intended email recipient is not a subscriber member of the PEN.

4. The method of claim 3 further comprising registering the intended email recipient as a subscriber member in response to receiving an indication that the intended email recipient accepts the offer to become a registered member of the PEN and a determination that the intended email recipient has a trusted and authenticated email client.

5. The method of claim 1 further comprising the step of delivering the header of the email designated approved for delivery to the email recipient in response to a request for email from the intended email recipient and a determination that the intended email recipient is using a trusted and authenticated email client associated with the intended email recipient.

6. The method of claim 1 transmitting the entire email to the intended email recipient in response to a request from the intended subscriber member and a determination that the intended email recipient is a using a trusted and authenticated email client associated with the intended email recipient.

7. A method for processing emails from an email sender to an enterprise member in a private email network (PEN) comprising the steps of:
receiving an email at a central post office from an email sender addressed to an enterprise member;
determining at the central post office if the email sender is a subscriber member of the PEN;
determining at the central post office if the email sender is a client of the enterprise member of the PEN;
designating the email approved for delivery in response to determining that the email sender is a subscriber member of the PEN and a client of the enterprise member.

8. The method of claim 7 further comprising the step of rejecting the email in response to a determination that the email sender is not a subscriber member and transmitting a notification to the email sender that the email was rejected.

9. The method of claim 7 further comprising the step of rejecting the email in response to determining that the email sender is not listed in the enterprise member's client directory and transmitting a rejection notification to the email sender and the enterprise member.

10. The method of claim 9 further comprising the step of adding the subscriber member to the enterprise member client directory in response to verifying that the subscriber member is a client of the enterprise member.

11. The method of claim 7 further comprising delivering the email to the enterprise member in response to a request from the enterprise member for delivery of email.

12. A method for processing emails from an email sender to an intended email recipient in a private email network (PEN) comprising the steps of:
receiving an email at a central post office from an email sender addressed to an intended email recipient;
determining at the central post office if the email sender is a subscriber member of the PEN;
determining at the central post office if the intended email recipient is included in a non-member whitelist associated with the email sender;
designating the email approved for delivery in response to determining that the email sender is a subscriber member of the PEN and the intended email recipient is included in a non-member whitelist associated with the email sender.

13. The method of claim 12 further comprising the step of rejecting the email in response to determining that the email sender is not a subscriber member of the PEN.

14. The method of claim 12 further comprising adding an intended email recipient to the non-member whitelist associated with the email sender in response to a determination that the intended email recipient is not included in the non-member whitelist associated with the email sender.

15. The method of claim 12 further comprising delivering the email to the intended email recipient in response to the email being approved for delivery.

16. A method for processing emails from an email sender to an intended email recipient in a private email network (PEN) comprising the steps of:
receiving an email at a central post office from an email sender addressed to an intended email recipient;
determining at the central post office if the intended email recipient is a subscriber member of the PEN;
determining at the central post office if the email sender is included in a non-member whitelist associated with the intended email recipient;
designating the email approved for delivery in response to determining that the intended email recipient is a subscriber member of the PEN and the email sender is included in a non-member whitelist associated with the intended email recipient.

17. The method of claim 16 further comprising the step of transmitting a request to the intended email recipient to add the email sender to the non-member whitelist associated with the intended email recipient in response to determining that the email sender is not included in the non-member whitelist associated with the intended email recipient and that the intended email recipient is a subscriber member.

18. The method of claim 17 further comprising the step of adding the email sender to the non-member whitelist associated with the intended email recipient in response to receiving an indication from the intended email recipient approving the request.

19. The method of claim 18 further comprising rejecting the email in response to receiving an indication from the intended email recipient rejecting the request.

20. The method of claim 17 further comprising designating the email for delivery in response to receiving an indication from the intended email recipient approving the request.

21. The method of claim 16 further comprising rejecting the email in response to determining that the intended email recipient is not a subscriber member.
